(19) United States
(12) Patent Application Publication
(10) Pub. No.: US 2025/0218018 A1
(43) Pub. Date: Jul. 3, 2025

(54) METHOD AND SYSTEM FOR SIMULTANEOUS LOCALIZATION AND MAPPING FOR A MOBILITY VEHCILE

(71) Applicants: HYUNDAI MOTOR COMPANY, Seoul (KR); KIA CORPORATION, Seoul (KR)

(72) Inventors: Sanghyeon Oh, Seoul (KR); Dong Hwan Kwak, Hwaseong-si (KR); Hyuntek Lim, Hwaseong-si (KR)

(73) Assignees: HYUNDAI MOTOR COMPANY, Seoul (KR); KIA CORPORATION, Seoul (KR)

(21) Appl. No.: 18/747,292

(22) Filed: Jun. 18, 2024

(30) Foreign Application Priority Data
Dec. 27, 2023 (KR) 10-2023-0193479

(51) Int. Cl. G06T 7/579; G06T 7/246; G06T 7/73; G06V 10/44; G06V 20/56

(52) U.S. Cl. CPC G06T 7/579; G06T 7/246; G06T 7/73; G06V 10/44; G06V 20/56

(57) ABSTRACT

A system for Simultaneous Localization and Mapping (SLAM) for a mobility vehicle includes a camera configured to acquire a front image of the mobility vehicle and a movement data sensor configured to detect movement data of the mobility vehicle. The system also includes a controller configured to receive the front image from the camera and detect a feature point from the front image. The controller is also configured to receive the movement data from the movement data sensor, track the detected feature point, and store a state of tracking the feature point. The state is selected from a first state indicating that a previously tracked first feature point is being tracked normally, a second state indicating that the first feature point has been lost and a second feature point is being tracked, and a third state indicating that the first and second feature points have been lost.

### CROSS-REFERENCE TO RELATED APPLICATION

This application claims priority to and the benefit of Korean Patent Application No. 10-2023-0193479 filed on Dec. 27, 2023, the entire contents of which are hereby incorporated herein by reference.

### BACKGROUND

### (a) Technical Field

The present disclosure relates to a method and a system for a Simultaneous Localization and Mapping (SLAM) for a mobility vehicle.

### (b) Description of the Related Art

Simultaneous Localization and Mapping (SLAM) is a technology that enables a mobility vehicle to detect current position of the mobility vehicle and simultaneously map surroundings while navigating through an unknown environment. SLAM is primarily performed based on light detection and ranging (lidar). However, SLAM based on lidar is expensive because a lidar sensor needs to be installed on the mobility vehicle. Accordingly, SLAM based on lidar is rarely applied to mobility vehicles that do not transport people and are only used indoors. Instead, SLAM based on camera images is mainly applied.

However, camera-based indoor environment SLAM may have difficulty in accurately extracting feature points from images detected by the camera due to disturbances such as white walls, feature pointless planes, and strong light, and SLAM may terminate when the feature points are lost for a long period of time.

The matters described in this related art section are provided to enhance understanding of the background of the present disclosure, and may include matters that are not already known to those having ordinary skill in the art to which the present technology pertains.

### SUMMARY

Embodiments of the present disclosure provide a method and a system for Simultaneous Localization and Mapping (SLAM) based on camera images for a mobility vehicle that continue SLAM with a localization based on movement data sensor despite losing feature points during SLAM with object tracking.

According to an embodiment of the present disclosure, a system for Simultaneous Localization and Mapping (SLAM) for a mobility vehicle is provided. The system includes a camera configured to acquire a front image of the mobility vehicle. The system also includes a movement data sensor configured to detect movement data of the mobility vehicle. The system further includes a controller configured to receive the front image of the mobility vehicle from the camera and detect a feature point from the front image. The controller is also configured to receive the movement data of the mobility vehicle from the movement data sensor. The controller is further configured to track the detected feature point and store a state of tracking the feature point. The state may be selected from among a first state indicating that a previously tracked first feature point is being tracked normally, a second state indicating that the first feature point has been lost and a second feature point is being tracked, and a third state indicating that the first feature point and second feature point have been lost.

The controller may be further configured to update a location of the mobility vehicle based on the movement data of the mobility vehicle in the third state.

The movement data sensor may include at least one of i) an encoder configured to detect information about a rotation of a drive motor or a wheel provided on the mobility vehicle and transmit the information to the controller or ii) an inertial sensor configured to detect information about a movement situation of the mobility vehicle, including a speed and a direction of the mobility vehicle, gravity, and acceleration and transmit the information to the controller.

The controller may be further configured to track the first feature point in the first state and store a frame including the first feature point as a first key frame. The controller may also be configured to temporarily track the second feature point in the second state after the first state and store a frame including the second feature point as a second key frame. The controller may further be configured to determine whether a distance between the first key frame and the second key frame is less than a set distance. The controller may additionally be configured to, in response to determining that the distance between the first key frame and second key frame is less than the set distance, input the first state as the state and store a current frame as the first key frame.

The controller may be further configured to, in response to determining that the distance between the first key frame and the second key frame is equal to or greater than the set distance, determine whether a time for which the state is maintained in the second state is greater than a set time. The controller may further be configured to, in response to determining that the time for which the state is maintained in the second state is greater than the set time, input the first state as the state and consider the second feature point as a new first feature point and track the second feature point.

The controller may be further configured to input the second state as the state and temporarily track the second feature point in response to determining that the time for which the state is maintained in the second state is less than the set time.

The controller may be further configured to, in response to losing the first feature point that was tracked and detecting the second feature point, input the second state as the state, store a frame including the second feature point as a second key frame, and update a location of the mobility vehicle based on the second key frame.

The controller may be further configured to input the state as the third state when a number of detected feature points is equal to or less than a set number.

According to another embodiment of the present disclosure, a method for Simultaneous Localization and Mapping (SLAM) for a mobility vehicle is provided. The method includes receiving, by a controller, a front image of the mobility vehicle from a camera in a state corresponding to a first state from among the first state indicating that a previously tracked first feature point is being tracked normally, a second state indicating that the first feature point has been lost and a second feature point is being tracked, and a third state indicating that the first and second feature points have been lost. The method also includes detecting a feature point from the front image. The method also includes, in response to determining that a number of feature points greater than a set number have been detected, storing, by the controller, a frame including a currently detected first feature point as a first key frame. The method further includes determining a location of the mobility vehicle based on the first feature point. The method additionally includes inputting, by the controller, the third state as the state in response to determining that a number of feature points equal to or less than the set number have been detected. The method further includes determining, by the controller, a location of the mobility vehicle based on movement data of the mobility vehicle.

The method may further include receiving, by the controller, the front image of the mobility vehicle from the camera in the third state and detecting the feature point from the front image. The method may also include inputting, by the controller, the second state as the state in response to determining that a number of the feature points greater than the set number have been detected. The method may additionally include determining, by the controller, the location of the mobility vehicle based on currently detected second feature point.

The method may further include receiving, by the controller, the front image of the mobility vehicle from the camera in the second state and detecting the feature point from the front image. The method may also include inputting, by the controller, the third state as the state in response to determining that the feature points equal to or less than the set number have been detected. The method may additionally include determining, by the controller, the location of the mobility vehicle based on the movement data of the mobility vehicle.

The method may further include receiving, by the controller, the front image of the mobility vehicle from the camera in the second state and detecting the feature point from the front image. The method may also include, in response to determining that a number of feature points greater than the set number have been detected, storing, by the controller, a frame including the currently detected second feature point as a second key frame and temporarily determining the location of the mobility vehicle based on the second feature point. The method may additionally include determining, by the controller, whether a distance between the first and second key frames is less than a set distance. The method may further still include, in response to determining that the distance between the first key frame and the second key frame is less than the set distance, inputting, by the controller, the first state as the state and storing a current frame as the first key frame.

The method may further include, in response to determining that the distance between the first key frame and the second key frame is equal to or greater than the set distance, determining, by the controller, whether a time for which the state is maintained in the second state is greater than a set time. The method may also include, in response to determining that the time for which the state is maintained in the second state is greater than a set time, inputting, by the controller, the first state as the state and considering the second feature point as a new first feature point and tracking the second feature point.

The method may further include, in response to determining that the time for which the state is maintained in the second state is less than the set time, inputting, by the controller, the second state as the state and temporarily determining the location of the mobility vehicle based on the second feature point.

The mobility vehicle may be detected by a movement data sensor. The movement data sensor may include at least one of i) an encoder configured to detect information about a rotation of a drive motor or a wheel provided on the mobility vehicle and transmit the information to the controller or ii) an inertial sensor configured to detect information about the movement situation of the mobility vehicle, including a speed and a direction of the mobility vehicle, gravity, and acceleration and transmit the information to the controller.

According to embodiments of the present disclosure, even when feature points are lost during Simultaneous Localization and Mapping (SLAM) with object tracking, SLAM may be continued with localization based on movement data sensor. This may ensure robustness of SLAM against disturbances, such as light.

In addition, when the lost feature point is detected again during SLAM with the localization based on the movement data sensor, the location of the mobility vehicle may be corrected based on a previous location and a current location of the feature point. Therefore, SLAM may be accurately performed.

Other effects that can be obtained or are expected from embodiments of the present disclosure are disclosed, directly or by implication, in the detailed description of the present disclosure. In other words, various effects obtained or expected according to the present disclosure are disclosed directly or implicitly in the following detailed description.

### BRIEF DESCRIPTION OF THE DRAWINGS

Embodiments of the present disclosure should be more clearly understood by reference to the following description in conjunction with the accompanying drawings, in which the same or functionally similar elements are designated with identical or similar reference numerals.

FIG. 1 is a block diagram of a system for Simultaneous Localization and Mapping (SLAM) for a mobility vehicle, according to an embodiment of the present disclosure.

FIGS. 2 and 3 are flow diagrams of a method for SLAM for a mobility vehicle, according to an embodiment of the present disclosure.

FIG. 4 is a diagram illustrating an example scenario of a method of SLAM for a mobility vehicle, according to an embodiment of the present disclosure.

It should be understood that the foregoing referenced drawings are not necessarily illustrated in accordance with the scale. The drawings present somewhat brief expression of various characteristics illustrating the basic principles of the present disclosure. For example, the specific design characteristics of the present disclosure including a specific dimension, direction, location, and shape may be partially determined by a particular intended application and use environment.

### DETAILED DESCRIPTION

The terms used herein are for the purpose of describing specific embodiments. The terms are not intended to limit the present disclosure. As used herein, singular expressions include plural expressions unless the context clearly dictates otherwise. The terms “include,” “including,” “have,” “having,” or the like, specify the presence of the mentioned characteristics, integers, operations, operations, constituent elements, and/or components when used in the present specification. However, it should be understood that such terms do not exclude the possibility of presence or addition of one or more of other characteristics, integers, operations, operations, constituent elements, components, and/or groups thereof. As used herein, the term “and/or” includes any one or all combinations of the associated and listed items.

As used herein, “mobility vehicle” or “of mobility vehicle” or other similar terms as used herein are inclusive of motor vehicles in general. Such motor vehicles include passenger vehicles, Sport Utility Vehicles (SUVs), buses, trucks, and various commercial vehicles. Such motor vehicles also include marine mobility vehicles including such as various boats and ships, and aerial mobility vehicles including aircraft and drones. Such motor vehicle generally include any object that is capable of moving under power from a motorized source. Further, as used herein, “mobility vehicle” or “of mobility vehicle” or other similar terms include hybrid mobility vehicles, electric mobility vehicles, plug-in hybrid mobility vehicles, hydrogen-powered mobility vehicles, and other alternative fuel (for example, fuel derived from resources other than petroleum) mobility vehicles. The hybrid mobility vehicles include mobility vehicles having two or more power sources, such as gasoline-powered and electric-powered mobility. Mobility vehicles according to embodiments of the present disclosure include manually driven mobility vehicles as well as autonomously and/or automatically driven mobility vehicles.

In addition, it should be understood that one or more of the methods according to embodiments of the present disclosure or aspects thereof may be executed by at least one or more controllers. The term “controller” may refer to a hardware device including a memory and a processor. The memory is configured to store program instructions, and the processor is specially programmed so as to execute program instructions to perform one or more processes described in more detail below. The controller may control operations of units, modules, components, devices, or similar matters thereof as described herein. Further, it should be understood that methods according to embodiments of the present disclosure may be executed by a device including a controller together with one or more other components as recognized by those having ordinary skill in the art.

Further, the controller of the present disclosure may be implemented as a non-transitory computer readable recording medium including program commands executable by a processor. Examples of the computer readable recording medium include a read only memory (ROM), a random access memory (RAM), a compact disc (CD) ROM, magnetic tapes, floppy discs, flash drives, smart cards, and/or optical data storage devices. However, the computer readable recording medium is not limited thereto. The computer readable recording medium may also be distributed across a computer network to store and execute program commands by a distributed method, such as a telematics server or a controller arear network (CAN).

When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings.

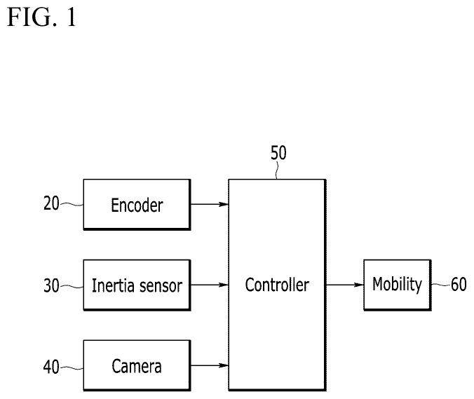

FIG. 1 is a block diagram of a system for Simultaneous Localization and Mapping (SLAM) for a mobility vehicle, according to an embodiment of the present disclosure.

As shown in FIG. 1, a SLAM system for a mobility vehicle, according to an embodiment of the present disclosure, includes an encoder 20, an inertial sensor 30, a camera 40, a controller 50, and a mobility vehicle 60.

The encoder 20 may detect information about a rotation of a drive motor or a wheel of the mobility vehicle 60. The encoder 20 may be connected to the controller 50 and may transmit information about the detected rotation of the drive motor or the wheel to the controller 50. The controller 50 may calculate movement data of the mobility vehicle 60, such as a movement speed and/or a distance traveled by the mobility vehicle 60, based on the information about the rotation of the drive motor or the wheel.

The inertial sensor 30 may detect information about a movement situation of the mobility vehicle 60, including the speed and the direction of the mobility vehicle 60, gravity, and acceleration. The inertial sensor 30 may be connected to the controller 50 and may transmit, to the controller 50, information about the detected movement situation of the mobility vehicle 60. The controller 50 may detect or supplement the movement data of the mobility vehicle 60 based on the information about the movement situation of the mobility vehicle 60.

While it is described above that both the encoder 20 and the inertial sensor 30 are used as movement data sensors to detect the movement data of the mobility vehicle 60, only one of the encoder 20 and the inertial sensor 30 may be used as the movement data sensor in some embodiments. Further, the movement data sensor is not limited to the encoder 20 and the inertial sensor 30. Rather, the movement data sensor may additionally, or alternatively, include a variety of other sensors that detect movement data of the mobility vehicle 60.

The camera 40 may be mounted on the mobility vehicle 60. The camera 50 may acquire a front image of the mobility vehicle 60 within the detecting range of the camera 40. The camera 40 may be connected to the controller 50 and may transmit the acquired images to the controller 50.

The controller 50 may receive i) the information about the rotation of the drive motor or the wheel from the encoder 20, ii) the information about the movement situation of the mobility vehicle 60 from the inertial sensor 30, and iii) the front image of the mobility vehicle 60 from the camera 40.

The controller 50 is configured to detect objects (for example, feature points) in the image by using an object detection algorithm, such as an artificial neural network, based on the received the front image. The controller 50 is configured to track the detected feature points and to determine the location of the mobility vehicle 60 based on the tracked feature points.

The controller 50 may detect the movement data of the mobility vehicle 60 based on the information about the rotation of the drive motor or the wheel received from the encoder 20 or the information about the movement situation of the mobility vehicle 60 received from the inertial sensor 30. The controller 50 may estimate the location of the mobility vehicle 60 based on the movement data of the mobility vehicle 60 when the feature points that were being tracked are lost. The controller 50 may also determine an absolute location of the mobility vehicle 60 by using the publicly known positioning method. The controller 50 is configured to perform SLAM based on the absolute location of the mobility vehicle 60 when the feature points that were being tracked are lost.

The controller 50 may be equipped with one or more microprocessors. The one or more microprocessors may be programmed to perform step or operations of SLAM according to embodiment of the present disclosure.

The controller 50 is connected to the mobility vehicle 60. The controller 50 may generate a route for the mobility vehicle 60 and/or control the movement of the mobility vehicle 60 by using a map created through the SLAM method according to embodiments of the present disclosure. For example, the controller 50 may control the mobility vehicle 60 to track the object or control the mobility vehicle 60 to avoid the object.

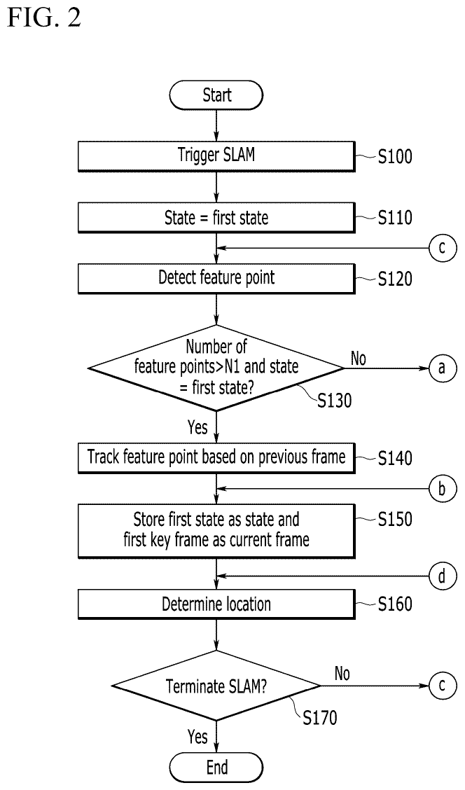

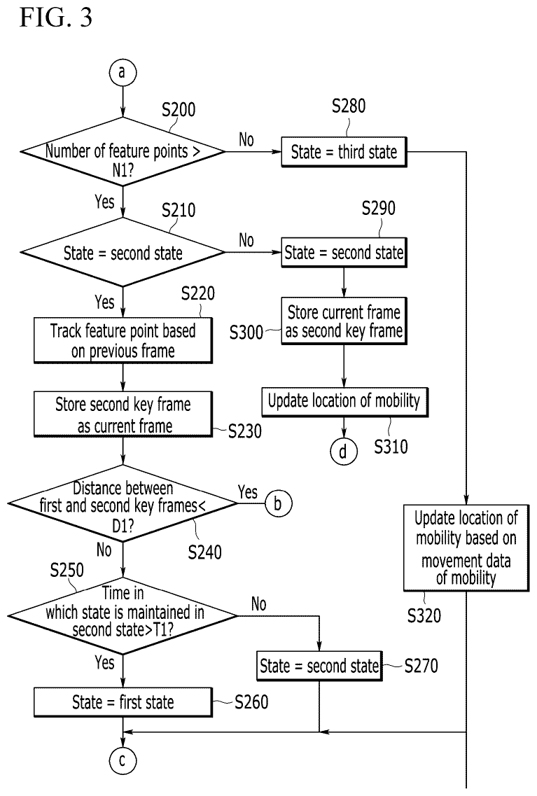

FIGS. 2 and 3 are flowcharts of a method for SLAM for a mobility vehicle, according to an embodiment of the present disclosure.

As shown in FIG. 2, the method for SLAM according to an embodiment of the present disclosure begins when the mobility vehicle 60 is powered on. For example, a user may press a start button on the mobility vehicle 60 or turn on the mobility vehicle 60 via a user interface.

Once the mobility vehicle 60 is powered up, in a step or operation S100, the user presses a SLAM button provided on the mobility vehicle 60 or triggers SLAM via the user interface. When SLAM is triggered, the controller 50 inputs a first state as a state in a step or operation S110. The camera 40 detects the front image of the mobility vehicle 60, and the controller 50 receives the front image of the mobility vehicle 60 from the camera 40. In a step or operation S120, the controller 50 detects feature points from the front image. Here, the state refers to a state that tracks a feature point. The state may include a first state, a second state, and a third state. The first state refers to the state in which a previously tracked first feature point is being tracked normally, the second state refers to the state in which a new second feature point is being tracked after the first feature point is lost, and the third state refers to the state in which the first feature point or the second feature point is lost. In an embodiment, in the step or operation S120, the first state is input as the default state when SLAM is triggered.

When the feature point is detected in the step or operation S120, the controller 50 determines whether the number of the feature points is greater than a set number N1 and the state is the first state in a step or operation S130. Here, the set number N1 may be, but is not limited to, 20.

When the processor 150 determines that the number of feature points is greater than the set number N1 and the state is the first state, the controller 50 performs a feature point tracking based on a previous frame in a step or operation S140. In one example, the controller 50 tracks the first feature point detected in the previous frame that was detected in a previous object detection cycle immediately preceding a current object detection cycle. In other words, the controller 50 tracks the first feature point detected in the previous frame and matches the feature point detected in the current frame with the first feature point detected in the previous frame. When no previous frame exists, for example when SLAM has just started, the controller 50 does not perform the step or operation S140, and the method proceeds to a step or operation S150.

When the feature point has been tracked based on the previous frame in the step or operation S140, the controller 50 inputs the first state as the state and stores the current frame as a first key frame in the step or operation S150. Here, the first key frame refers to the frame that is the reference to track the first feature point in a next object detection cycle in the first state. In other words, the first key frame has all the first feature points that are being tracked in the first state. For example, the first key frame stored in the step or operation S150 becomes the previous frame in the step or operation S140 in the next object detection cycle.

In a step or operation S160, the controller 50 determines the location of the mobility vehicle 60 based on the tracked first feature point. The method of determining the location of the mobility vehicle 60 based on the first feature point is well known to those having ordinary skill in the art and a detailed description thereof has been omitted.

When the location of the mobility vehicle 60 has been determined, the controller 50 determines whether SLAM has ended in a step or operation S170. When the processor 50 determines that SLAM has ended, the controller 50 terminates the method according to the embodiment of the present disclosure. In contrast, when the processor 50 determines that SLAM has not ended, the method proceeds to the step or operation S120, and when the next object detection cycle arrives, the controller 50 detects the feature point from the image acquired by the camera 40.

Referring again to the step or operation S130, when the number of feature points at is equal to or less than the set number N1 or the state is not the first state, the method proceeds to a step or operation S200. As shown in FIG. 3, in the step or operation S200, the controller 50 determines whether the number of feature points is greater than the set number N1.

When it is determined in the step or operation S200 that the number of feature points is greater than the set number N1, the controller 50 determines whether the state is the second state in a step or operation S210. In other words, since the number of feature points is greater than the set number N1, the controller 50 determines whether the state is the second state or the third state.

When the state is determined to be the second state in the step or operation S210, the controller 50 performs the feature point tracking based on the previous frame in a step or operation S220. When the number of feature points is greater than the set number N1 and the state is the second state, some of the first feature points that were being tracked have been lost but new second feature points have been detected, and the new second feature points may be tracked. Thus, when the state determined in the step or operation S210 is the second state and indicates that the new second feature point is tracked, the controller 50 tracks the second feature point detected in the previous frame that was detected in the previous object detection cycle immediately preceding the current object detection cycle. In other words, the controller 50 tracks the second feature point detected in the previous frame and matches the feature point detected in the current frame with the second feature point detected in the previous frame.

When the feature point has been tracked based on the previous frame in the step or operation S220, the controller 50 stores the current frame as a second key frame in a step or operation S230. Here, the second key frame refers to the frame that is the reference to track the second feature point in the next object detection cycle in the second state. In other words, the second key frame has all the second feature points that are being tracked in the second state. For example, the second key frame stored in the step or operation S230 becomes the previous frame in the step or operation S220 in the next object detection cycle.

When the second key frame is stored in the step or operation S230, the controller 50 determines whether a distance between the first and second key frames is less than a set distance D1 in a step or operation S240. If the first key frame with the previously tracked first feature point and the second key frame with the currently tracked second feature point are close, it may be determined that the first feature point previously tracked and lost has been found again. Thus, the processor 50 determines, in the step or operation S240, whether the second feature point currently being tracked is the same as the previously lost first feature point. Here, the set distance D1 may be set to any distance determined appropriate by those having ordinary skill in the art.

When the distance between the first and second key frames is less than the set distance D1 in the step or operation S240, the method proceeds to the or operation step S150, and the controller 50 inputs the first state as the state and stores the current frame as the first key frame. When the distance between the first and second key frames is less than the set distance D1, the lost first feature point is found again. Accordingly, the controller 50 returns the state to the first state and stores the current frame as the first key frame.

When the distance between the first and second key frames is equal to or greater than the set distance D1 in the step or operation S240, the controller 50 determines whether the time for which the state is maintained in the second state is greater than a set time T1 in a step or operation S250. When the time for which the state is maintained in the second state in the step or operation S250 is greater than the set time T1, it is determined that the lost first feature point has not been found again but the new second feature point is being tracked stably. Accordingly, the controller 50 inputs the first state as the state at step S260 and the method proceeds to the step or operation S120. Thus, when the next object detection cycle arrives, the controller 50 detects the feature point from the image acquired by the camera 40 in the step or operation S120.

When the controller 50 determines that the time for which the state is maintained in the second state is equal to or less than the set time T1 in the step or operation S250, the controller 50 tries to find the lost first feature point again and maintains the second state where the new second feature point is tracked in a step or operation S270. Thereafter, the method proceeds to the step or operation S120, and when the next object detection cycle arrives, the controller 50 detects the feature point from the image acquired by the camera 40.

Referring again to the step or operation S210, when the controller 50 determines that the state is not the second state, the controller 50 has lost the first feature point that was being tracked, but has found the second feature point sufficient to perform feature point tracking. Accordingly, the controller 50 inputs the second state as the state in a step or operation S290 and begins tracking the new second feature point. To this end, the controller 50 stores the current frame as the second key frame at a step or operation S300 to store a frame that serves as a reference to track the feature point in the next object detection cycle in the second state. Thereafter, the controller 50 updates the location of the mobility vehicle 60 based on the new second feature point in a step or operation S310. The method then proceeds to the step or operation S160 in which the controller 50 determines the location of the mobility vehicle 60.

Referring again to the step or operation S250, when the number of feature points is equal to or less than the set number N1, the controller 50 determines that the first feature point or the second feature point that was being tracked has been lost and the feature point-based SLAM cannot be performed, and inputs the third state as the state in a step or operation S280. Thereafter, the controller 50 updates the location of the mobility vehicle 60 based on the movement data of the mobility vehicle 60 in a step or operation S320. For example, the controller 50 may detect the movement data of the mobility vehicle 60 based on the information about the rotation of the drive motor or the wheel received from the encoder 20 or the information about the movement situation of the mobility vehicle 60 received from the inertial sensor 30, and may update the current location of the mobility vehicle 60 by adding the movement data of the mobility vehicle 60 to the previous location of the mobility vehicle 60.

Once the location of the mobility vehicle 60 is updated, the method proceeds to the step or operation S120, and when the next object detection cycle arrives, the controller 50 detects the feature point from the image acquired by the camera 40.

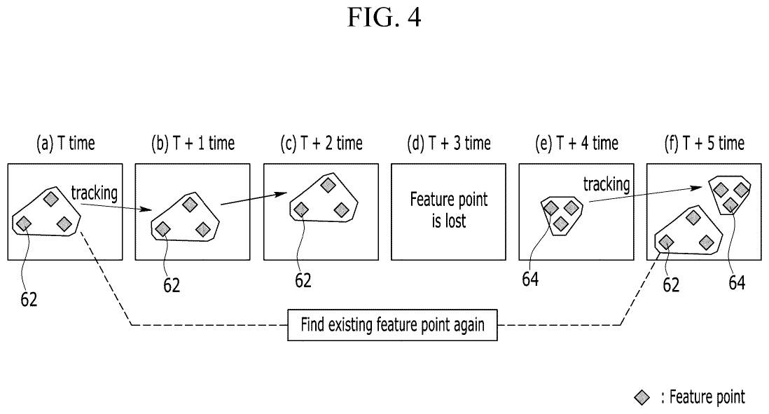

FIG. 4 is a diagram illustrating an example scenario of a method for SLAM for a mobility vehicle according to an embodiment of the present disclosure.

Referring to FIG. 4, the controller 50 begins to track the first feature point 62 at a time T and continues to track the first feature point 62 until a time (T+2). In this case, the steps or operations S110-S170 are repeated.

At a time (T+3), the controller 50 loses the first feature point that was being tracked. In this case, in the step or operation S130, the number of feature points is equal to or less than the set number N1. Accordingly, the method proceeds to the step S200. Further, in the step S200, since the number of feature points is equal to or less than the set number N1, the controller 50 inputs the third state as the state in the step S280 and updates the location of the mobility vehicle 60 based on the movement data of the mobility vehicle 60.

At a time (T+4), the controller 50 detects a new second feature point 64 in the step or operation S120, and since the number of feature points 64 is greater than the set number N1 but the state is the third state, the method proceeds to the step or operation S290 through the steps or operations S130, S200, and S210. The controller 50 begins to track the new second feature point 64 by inputting the second state as the state in the step or operation S290. Accordingly, the controller 50 stores the current frame as the second key frame in the step or operation S300, updates the location of the mobility vehicle 60 based on the new second feature point 64 in the step or operation S310, and determines the location of the mobility vehicle 60 in the step or operation S160.

At a time (T+5), the controller 50 detects and tracks the second feature point 64 and at the same time detects another first feature point 62 in the step or operation S120, and since the number of feature points 62 and 64 is greater than the set number N1 but the state is the second state, the method proceeds to the step or operation S220 through the steps S130, S200, and S210. The controller 50 tracks the second feature point 64 based on the previous frame (i.e., the second key frame stored at time (T+4)) in the step or operation S220 and stores the current frame as the second key frame in the step or operation S230. The second key frame includes the second feature point 64 that is currently being tracked and another first feature point 62.

Thereafter, the controller 50 compares the distance between the first key frame (the previously tracked but lost first feature point 62) and the second key frame (the currently tracked second feature point 64 and another first feature point 62) in the step or operation S240. Since the distance between the first and second key frames is less than the set distance D1 (i.e., the lost first feature point 62 has been found again), the method proceeds to the step or operation S150, and the controller 50 inputs the first state as the state and stores the current frame as the first key frame. Further, by comparing the location of the mobility vehicle 60 based on the second feature point 64 to the location of the mobility vehicle 60 based on the first feature point 62, the location of the mobility vehicle 60 may be corrected and optimized.

While this disclosure has been described in connection with what is presently considered to be practical example embodiments, it should be understood that the disclosure is not limited to the described embodiments. On the contrary, the present disclosure is intended to cover various modifications and equivalent arrangements included within the spirit and scope of the appended claims.

What is claimed is:

1. A system for Simultaneous Localization and Mapping (SLAM) for a mobility vehicle, the system comprising:
a camera configured to acquire a front image of the mobility vehicle;
a movement data sensor configured to detect movement data of the mobility vehicle; and
a controller configured to
receive the front image of the mobility vehicle from the camera,
detect a feature point from the front image,
receive the movement data of the mobility vehicle from the movement data sensor,
track the detected feature point, and
store a state of tracking the feature point,
wherein the state is selected from among
a first state indicating that a previously tracked first feature point is being tracked normally,
a second state indicating that the first feature point has been lost and a second feature point is being tracked, and
a third state indicating that the first feature point and the second feature point have been lost.

2. The system of claim 1, wherein the controller is further configured to update a location of the mobility vehicle based on the movement data of the mobility vehicle in the third state.

3. The system of claim 1, wherein the movement data sensor includes at least one of
an encoder configured to detect information about a rotation of a drive motor or a wheel provided on the mobility vehicle and transmit the information to the controller, or
an inertial sensor configured to detect information about a movement situation of the mobility vehicle, including a speed and a direction of the mobility vehicle, gravity, and acceleration, and transmit the information to the controller.

4. The system of claim 1, wherein the controller is further configured to:
track the first feature point in the first state and store a frame including the first feature point as a first key frame;
temporarily track the second feature point in the second state after the first state and store a frame including the second feature point as a second key frame;
determine whether a distance between the first key frame and the second key frame is less than a set distance; and
in response to determining that the distance between the first key frame and the second key frame is less than the set distance, input the first state as the state and store a current frame as the first key frame.

5. The system of claim 4, wherein the controller is further configured to:
in response to determining that the distance between the first key frame and the second key frame is equal to or greater than the set distance, determine whether a time for which the state is maintained in the second state is greater than a set time; and
in response to determining that the time for which the state is maintained in the second state is greater than the set time, input the first state as the state and consider the second feature point as a new first feature point and track the second feature point.

6. The system of claim 5, wherein the controller is further configured to input the second state as the state and temporarily track the second feature point in response to determining that the time for which the state is maintained in the second state is less than the set time.

7. The system of claim 1, wherein the controller is further configured to, in response to losing the first feature point that was tracked and detecting the second feature point:
input the second state as the state;
store a frame including the second feature point as a second key frame; and
update a location of the mobility vehicle based on the second key frame.

8. The system of claim 1, wherein the controller is further configured to input the state as the third state when a number of detected feature points is equal to or less than a set number.

9. A method for Simultaneous Localization and Mapping (SLAM) for a mobility vehicle, the method comprising:
receiving, by a controller, a front image of the mobility vehicle from a camera in a state being a first state from among the first state indicating that a previously tracked first feature point is being tracked normally, a second state indicating that the first feature point has been lost and a second feature point is being tracked, and a third state indicating that the first and second feature points have been lost;
detecting a feature point from the front image;
in response to determining that a number of feature points is greater than a set number have been detected, storing, by the controller, a frame including a currently detected first feature point as a first key frame;
determining a location of the mobility vehicle based on the first feature point;
inputting, by the controller, the third state as the state in response to determining that a number of feature points equal to or less than the set number have been detected; and
determining, by the controller, the location of the mobility vehicle based on movement data of the mobility vehicle.

10. The method of claim 9, further comprising:
receiving, by the controller, the front image of the mobility vehicle from the camera in the third state and detecting the feature point from the front image;
inputting, by the controller, the second state as the state in response to determining that a number of feature points greater than the set number have been detected; and
determining, by the controller, the location of the mobility vehicle based on currently detected second feature point.

11. The method of claim 10, further comprising:
receiving, by the controller, the front image of the mobility vehicle from the camera in the second state and detecting the feature point from the front image;
inputting, by the controller, the third state as the state in response to determining that the feature points equal to or less than the set number have been detected; and
determining, by the controller, the location of the mobility vehicle based on the movement data of the mobility vehicle.

12. The method of claim 10, further comprising:
receiving, by the controller, the front image of the mobility vehicle from the camera in the second state and detecting the feature point from the front image;
in response to determining that a number of feature points greater than the set number have been detected, storing, by the controller, a frame including the currently detected second feature point as a second key frame and temporarily determining the location of the mobility vehicle based on the second feature point;
determining, by the controller, whether a distance between the first key frame and the second key frame is less than a set distance; and
in response to determining that the distance between the first key frame and the second key frame is less than the set distance, inputting, by the controller, the first state as the state and storing a current frame as the first key frame.

13. The method of claim 12, further comprising:
in response to determining that the distance between the first key frame and the second key frame is equal to or greater than the set distance, determining, by the controller, whether a time for which the state is maintained in the second state is greater than a set time; and
in response to determining that the time for which the state is maintained in the second state is greater than the set time, inputting, by the controller, the first state as the state and considering the second feature point as a new first feature point and tracking the second feature point.

14. The method of claim 13, further comprising, in response to determining that the time for which the state is maintained in the second state is less than the set time, inputting, by the controller, the second state as the state and temporarily determining the location of the mobility vehicle based on the second feature point.

15. The method of claim 9, wherein the movement data of the mobility vehicle is detected by a movement data sensor, wherein the movement data sensor includes at least one of
an encoder configured to detect information about a rotation of a drive motor or a wheel provided on the mobility vehicle and transmit the information to the controller, or
an inertial sensor configured to detect information about movement of the mobility vehicle, including a speed and a direction of the mobility vehicle, gravity, and acceleration, and to transmit the information to the controller.
